(19) United States
(12) Patent Application Publication
(10) Pub. No.: US 2002/0026647 A1
(43) Pub. Date: Feb. 28, 2002

(54) Multimedia device whose functions can be extended and method for extending functions

(75) Inventors: Myung-sik Yim, Gyeonggi-do (KR); Jae-moon Jo, Gyeonggi-do (KR)

Correspondence Address: SUGHRUE, MION, ZINN,, MACPEAK & SEAS, PLLC, 2100 Pennsylvania Avenue, NW, Washington, DC, 20037-3213, US

(73) Assignee: SAMSUNG ELECTRONICS CO., LTD

(21) Appl. No.: 09/848,503

(22) Filed: May 4, 2001

(30) Foreign Application Priority Data
May 6, 2000 (KR) 2000-24211

(51) Int. Cl. H04N 7/16; H04N 7/00

(52) U.S. Cl. 725/152; 725/151; 348/552

(57) ABSTRACT

A multimedia device whose functions can be extended and a method for extending functions are provided. The multimedia device has a backplane unit having a plurality of connectors provided thereon, each of the connectors having a predetermined signal standard; a main board unit, which is plugged into a connector of the backplane unit, for processing an MPEG transport stream input from an extension board into a predetermined signal form, and selecting an extension board; and an extension board, which is attachable to any one of the connectors of the backplane, excluding the connector into which the main board unit is plugged, for transmitting an MPEG transport stream processed by an independent module to the main board unit when selected by the main board unit.

### BACKGROUND OF THE INVENTION

1. Field of the Invention

The present invention relates to a multimedia system including a television, and more particularly, to a multimedia device whose functions can be extended, and a method for extending functions of the same.

2. Description of the Related Art

In general, the life span of a television is about ten years, but multimedia devices having various functions have shorter life spans than an ordinary television. Therefore, a television, which is manufactured to have various multimedia functions, needs to have its multimedia functions upgraded for the market. For example, consumers expect that a projection television can be used for about ten years because it is expensive. As for an Internet set-top box, its browser function should be upgraded, and some of its hardware, such as a central processing unit, should be upgraded once every few years to maintain normal operation. However, many multimedia devices including conventional television sets, lack a structure enabling upgrading, and therefore it is difficult to extend the functions of the multimedia devices.

### SUMMARY OF THE INVENTION

To solve the above problems, it is an object of the present invention to provide a multimedia device for extending functions by forming a backplane into which a main board and extension boards can be plugged.

It is another object to provide a method for extending functions using a multimedia device formed with a backplane in which a main board and extension boards can be plugged.

To accomplish the above object of the present invention, there is provided a multimedia device in a multimedia system, the multimedia device having a backplane unit having a plurality of connectors provided thereon, each of the connectors having a predetermined signal standard; a main board unit, which is plugged into a connector of the backplane unit, for processing an MPEG transport stream input from an extension board into a predetermined signal form, and selecting an extension board; and an extension board, which is attachable to any one of the connectors of the backplane, excluding the connector into which the main board unit is plugged, for transmitting an MPEG transport stream processed by an independent module to the main board unit when selected by the main board unit.

It is preferable that each connector of the backplane has lines for a transmission signal for transmitting a control command of the main board to the extension board; an MPEG transport stream; an analog audio/video signal; and a selection signal for selecting an extension board.

To accomplish another object of the present invention, there is also provided a multimedia device in a multimedia system, the multimedia device having a combination main board unit, in which a backplane formed of a plurality of connectors, each of the connectors having a predetermined signal standard, and a main board for processing a multimedia input signal into a predetermined signal and selecting an extension board are combined; and an extension board, which is attachable to any one of the connectors of the backplane, separately from the combination main board, for performing extended functions, according to the main board's selection.

To accomplish another object of the present invention, there is also provided a method for extending functions of a multimedia device having a backplane, a main board, and extension boards plugged into the backplane, the method for extending functions having the steps of (a) determining whether or not the extension boards are plugged into the backplane, by sequentially scanning connectors plugged on the backplane; (b) analyzing the characteristic of an extension board, if it is determined in the step (a) that the extension board is plugged into the backplane; (c) performing functions according to the characteristics of the extension board analyzed in the step (b); and (d) displaying a signal corresponding to the function of the extension board performed in the step (c), on a screen.

### BRIEF DESCRIPTION OF THE DRAWINGS

The above objects and advantages of the present invention will become more apparent by describing in detail preferred embodiments thereof with reference to the attached drawings in which:

FIG. 1 illustrates a backplane having extension slots in a multimedia device according to a preferred embodiment of the present invention;

FIG. 2 illustrates signal standards of a connection in the backplane of FIG. 1;

FIG. 3 illustrates the structure of a main board plugged into the backplane of FIG. 1;

FIG. 4 illustrates the structure of a first-type extension board plugged in the backplane of FIG. 1;

FIG. 5 is a detailed diagram of the independent module of FIG. 4;

FIG. 6 illustrates the structure of a second-type extension board plugged in the backplane of FIG. 1; and

FIG. 7 is a flowchart for showing a method for extending functions of a television system according to a preferred embodiment of the present invention.

### DETAILED DESCRIPTION OF THE INVENTION

Hereinafter, embodiments of the present invention will be described in detail with reference to the attached drawings. The present invention is not restricted to the following embodiments, and many variations are possible within the spirit and scope of the present invention. The embodiments of the present invention are provided in order to more completely explain the present invention to anyone skilled in the art.

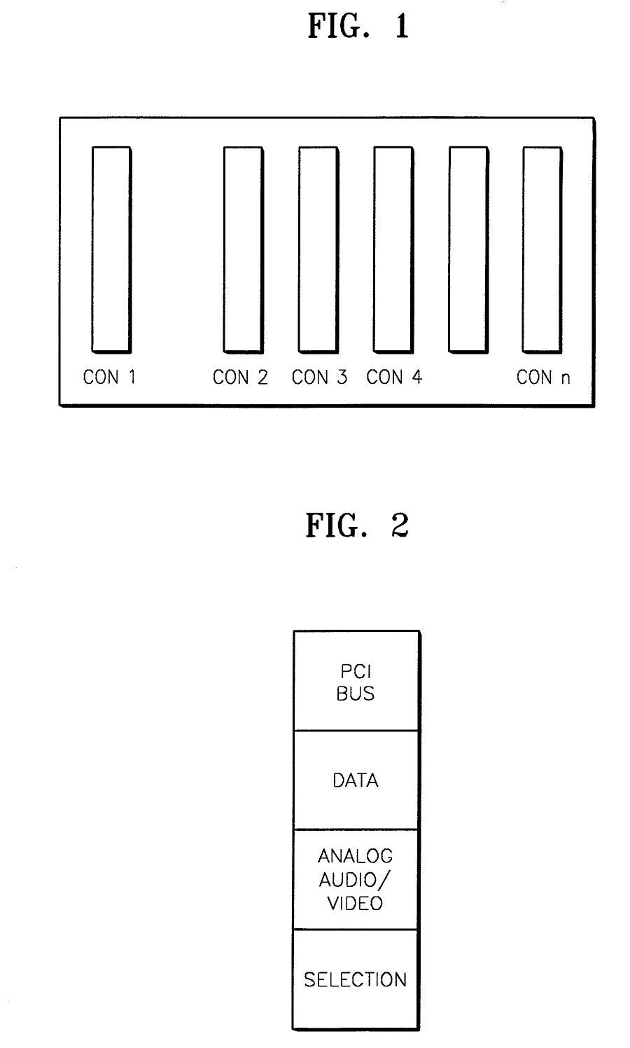

FIG. 1 illustrates a backplane having extension slots in a multimedia device according to a preferred embodiment of the present invention.

Referring to FIG. 1, a main integrated circuit board is plugged into a first connector (Con1). Extension integrated circuit boards are plugged into a second connector (Con 2) through an n-th connector (Con n). Alternatively, the backplane and the main board can be manifested as one in the same board and separate extension boards can be plugged into the backplane/main board. Also, when the multimedia device is first purchased, the purchaser can choose certain extended boards to be mounted therein, or after the user first buys the backplane with a separate main board being plugged into the backplane, the user can buy and mount extension boards later when he needs to add new functions.

FIG. 2 illustrates signal standards of a connection in the backplane of FIG. 1.

Referring to FIG. 2, the signal standards of each connector plugged into a slot of the backplane are a peripheral component interconnect (PCI) bus signal, a data signal, an analog audio/video signal, and a selection signal.

Here, the PCI bus signal is a signal standard which has been generally used in personal computers since Intel Co. set up the standard. The data signal is a standard for transmitting a moving picture experts group (MPEG) transport stream (TS). The analog audio/video signal is output in the form of an analog signal from the terminal. The selection signal is for selecting an extension board to receive data or an audio/video signal, among extension boards plugged into the first connector (Con 1) through the n-th connector (Con n).

Excluding the PCI bus signal which is generally used in a personal computer, the remaining signals can be briefly explained as follows:

1) Data signal

| Signal | | |
|---|---|---|
| name | Explanation | Remarks |
| TS data | Signal containing MPEG TS | Input signal through the first |
| (8 bits) | data to be transmitted | connector (Con 1) |
| | (from an | Output signals through the |
| | extension board to the main | second connector (Con 2) |
| | board) | - n-th connector (Con n) |
| TS clock | Clock for transmitting an | Input signal through the first |
| (1 bit) | MPEG TS. Data is read using | connector (Con 1) |
| | a TS clock in the main board. | Output signals through the |
| | | second connector (Con 2) |
| | | - n-th connector (Con n) |
| TS enable | Signal for indicating that an | Input signal through the first |
| (1 bit) | MPEG TS is transmitted. TS | connector (Con 1) |
| | data is read using a TS clock | Output signals through the |
| | for the duration of TS enable | second connector (Con 2) |
| | signal being active. | - n-th connector (Con n) |

2) Analog audio/video signal

| Signal name | Explanation | Remarks |
|---|---|---|
| Luminance signal | Luminance signal in a video | Input signal through the first |
| | signal (For example: Y) | connector (Con 1) |
| | | Output signals through the |
| | | second connector (Con 2) |
| | | - n-th connector (Con n) |
| Color signal 1 | Color signal 1 in a video signal | Input signal through the first |
| | (For example: C signal in | connector (Con 1) |
| | NTSC, Pb in HDTV) | Output signals through the |
| | | second connector (Con 2) |
| | | - n-th connector (Con n) |
| Color signal 2 | Color signal 2 in a video signal | Input signal through the first |
| | (For example: Pb in HDTV) | connector (Con 1) |
| | | Output signals through the |
| | | second connector (Con 2) |
| | | - n-th connector (Con n) |
| Sync. signal | Sync. signal in a video signal | Input signal through the first |
| | | connector (Con 1) |
| | | Output signals through the |
| | | second connector (Con 2) |
| | | - n-th connector (Con n) |
| Audio signal 6 channels | Analog audio signal of 5.1 | Input signal through the first |
| | channel | connector (Con 1) |
| | | Output signals through the |
| | | second connector (Con 2) |
| | | - n-th connector (Con n) |

3) Selection signal

The selection signal is provided to the first connector (Con 1) through the n-th connector (Con n). The first connector (Con 1) has n signal lines while each of the second connector (Con 2) through the n-th connector (Con n) has one signal line.

\mathring{1} First connector (Con 1)

| | | |
|---|---|---|
| Signal name | Explanation | Remarks |

| | |
|---|---|
| Second connector (Con 1) | Signal for indicating that the |
| selection signal | extension board plugged into |
| | the second connector (Con 1) |
| | is selected and the signal of |
| | the selected board is finally |
| | displayed |
| N-th connector (Con n) | Signal for indicating that the |
| selection signal | extension board plugged into |
| | the n-th connector (Con n) is |
| | selected and the signal of the |
| | selected board is finally |
| | displayed |

\mathring{2} Second connector (Con 2) through n-th connector (Con n)

| | | |
|---|---|---|
| Signal name | Explanation | Remarks |

| | |
|---|---|
| Selection signal | Signal for indicating that the |
| | corresponding connector is |
| | selected |

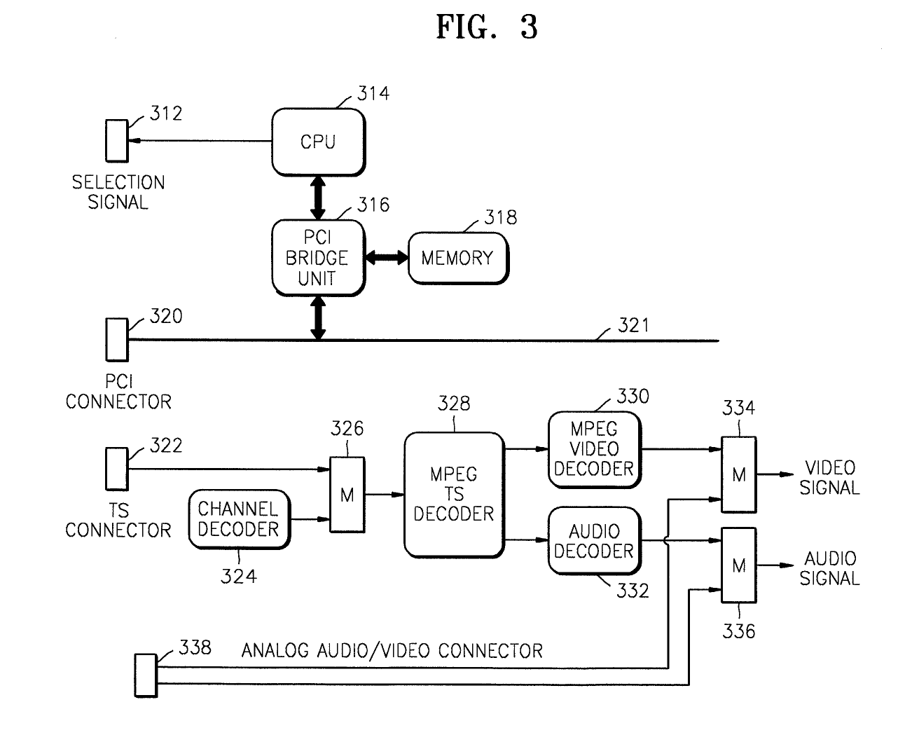

FIG. 3 illustrates the structure of a main board plugged into the backplane of FIG. 1.

Referring to FIG. 3, the main board has an architecture based on the PCI bus 321, and the PCI bus 321 is connected to the PCI connector 320.

A PCI bridge unit 316 converts a CPU bus signal into a PCI bus signal, and reads and writes data in a memory 318. A CPU 314 controls all blocks plugged on the main board with control signals.

Also, the main board basically has an MPEG TS decoder 328, an MPEG video decoder 330, an audio decoder 332, a TS switch 326, a first analog signal switch 334 and a second analog signal switch 336.

First, the TS switch 326 selects one of a transport stream (TS) received through the TS connector 322 and a TS input through the channel decoder 324.

The MPEG TS decoder 328 can demultiplex or decode a TS output from the TS switch 326, and can decode a TS input from the channel decoder 324. Since an HDTV basically has a channel decoder for receiving a ground wave digital TV signal on the main board, the HDTV can receive and display a ground wave HDTV signal.

The first analog signal switch 334 selects one of an analog video signal received through the analog audio/video connector 338, and a video signal generated in the MPEG video decoder 330.

The second analog signal switch 336 selects one of an analog audio signal received through the analog audio/video connector 338, and an audio signal generated in the MPEG audio decoder 332.

The CPU 314 generates a signal for selecting an extension board among extension boards plugged into the second connector (Con 2) through the n-th connector (Con n), and provides the signal to a selection signal connector 312. When the CPU 314 selects one extension board among the extension boards plugged into the second connector (Con 2) through the n-th connector (Con n) using the selection signal, the selected extension board transmits a signal through either the TS connector 322 or the analog audio/video connector 338. At the same time, if data is input to the TS connector 322 in the main board, the main board CPU 314 drives the MPEG TS decoder 328, the audio decoder 332, and the MPEG video decoder 330 so that the final video/audio signal is output by driving, and if the analog audio/video connector 338 receives the signal, this signal is output as the final signal.

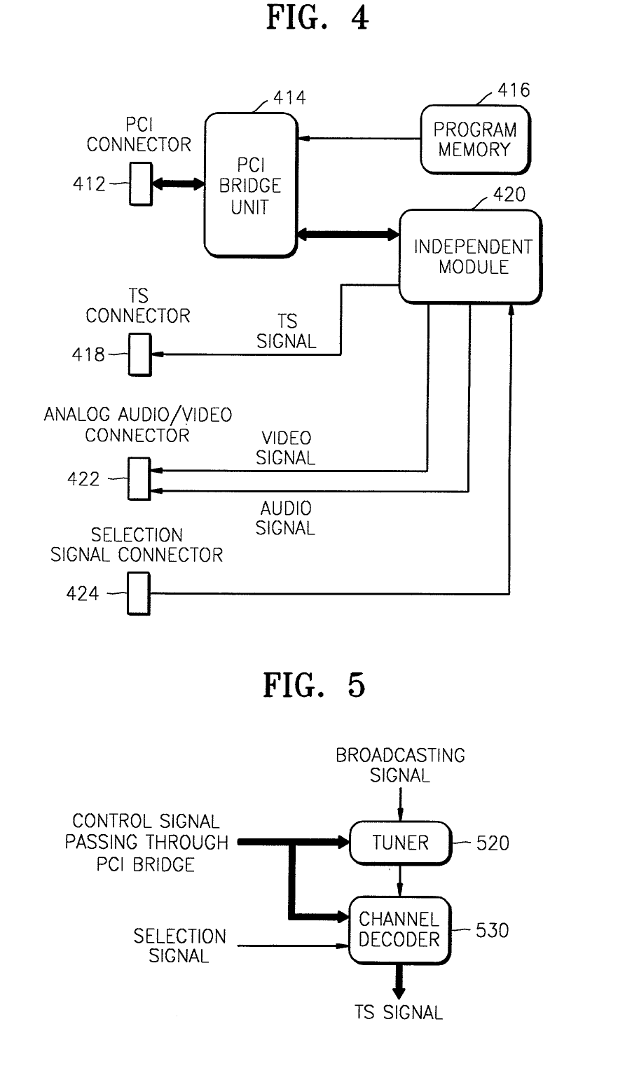

FIG. 4 illustrates the structure of a first-type extension board plugged in the backplane of FIG. 1.

The extension board of FIG. 4 basically has a PCI bridge unit 414, a program memory 416, and an independent module 420, and additionally has a PCI connector 412 , a TS connector 418, an analog audio/video connector 422, and a selection signal connector 424 for connecting signals of each block.

The program memory 416 internally has a program for controlling the independent module 420 when the corresponding extension board is selected. For example, when the CPU is plugged on the main board, the program memory 416 stores codes which the CPU can execute. Therefore, if the CPU 314 of the main board desires to control the independent module 420 of the extension board, the CPU 314 executes the program code stored in the program memory 416. In this case, the extension board should know in advance the CPU plugged on the main board.

When selected by a selection signal input from the selection signal connector 424, the independent module 420 transmits a TS or an analog audio/video signal. If it is not selected, the independent module 420 does not transmit a TS output and an analog audio/video signal.

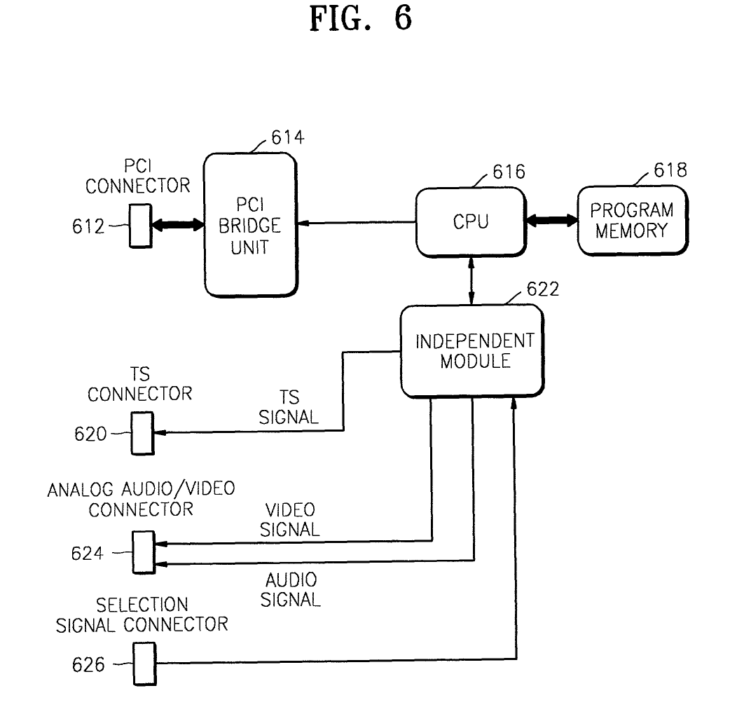

An embodiment of the independent module 420 can be, for example, a satellite broadcasting receiving module, a digital video disc player (DVDP), or a cable broadcasting receiving module. As shown in FIG. 5, when a satellite broadcasting receiving module is the independent module 420, the independent module 420 converts a broadcasting signal input through a turner 520 and a channel decoder 530 into an MPEG TS signal according to a PCI bridge control signal and a selection signal.

Also, when a DVDP is the independent module 420, the independent module decodes a DVDP signal and transmits a signal for displaying on the screen.

FIG. 6 illustrates the structure of a second-type extension board plugged in the backplane of FIG. 1.

The extension board of FIG. 6 basically has a PCI bridge unit 614, a CPU 616, a program memory 618, and an independent module 622, and additionally has a PCI connector 612, a TS connector 620, an analog audio/video connector 624, and a selection signal connector 626, for connecting signals of each block.

Referring to FIG. 6, when the corresponding extension board is selected, the CPU 616 receives a command generated in the CPU 314 of the main board in the form of a message through the PCI bus, and transmits the result of execution to the CPU 314 of the main board through the PCI bridge unit 614. At this time, the CPU 616 of the extension board communicates signals in hyper text markup language (HTML) with the CPU 314 of the main board.

The main board and extension boards exchange messages as a client and server of the Word Wide Web (WWW) exchange messages. For example, the main board corresponds to a client and an extension board corresponds to a server. If the main board desires to drive the operation of an extension board, the CPU 314 of the main board requests to drive the extension board through the PCI bus and then the extension board, functioning as the server, transmits its menu in HTML to the CPU 314 of the main board through the PCI bus. At this time, the main board CPU 314 drives a web browser to display the received HTML on a screen so that the user can select a menu item, watching the web page displayed on the screen. As a result, the extension board CPU 616 executes the command corresponding to the menu item selected by the main board CPU 314.

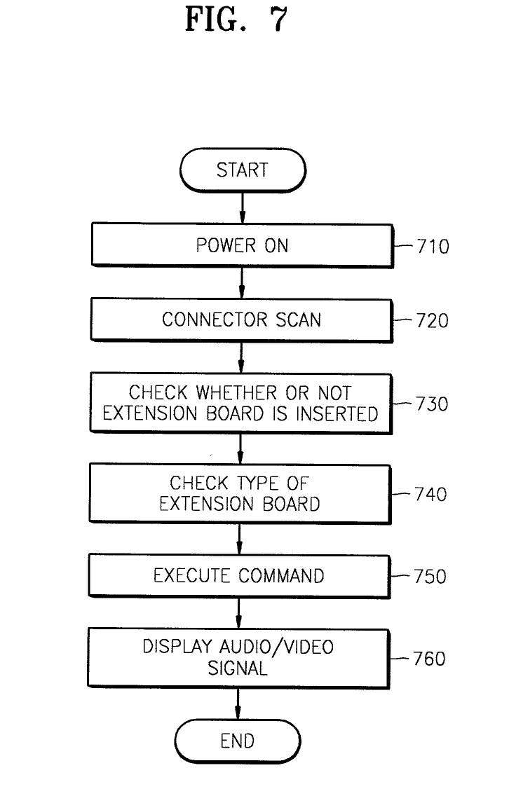

FIG. 7 is a flowchart for showing a method for extending functions of a television system according to a preferred embodiment of the present invention.

First, the television is turned on in step 710, the CPU 314 of the main board plugged into the first connector (Con 1) initializes the main board, and then sequentially scans from the second connector (Con 2) through the n-th connector (Con n) in step 720.

Then, after the PCI configuration process, which is common in an ordinary personal computer, the main board CPU 314 determines which connectors among the second connector (Con 2) through the n-th connector (Con n) have extended boards mounted therein in step 730. For example, the CPU 314 reads vendor IDs or device IDs from PCI registers corresponding to each slot in PCI configuration, and if values other than “0×00” or “0×FFFFFFFF” are read, recognizes that an extension board is plugged into the slot. The CPU 314 recognizes that vendor IDs or device IDs are “0×00” or “0×FFFFFFFF” when an extension board is not plugged into the slot.

Next, after checking whether or not an extension board is plugged into each of the slots, the main board CPU 314 determines the characteristics of any extension boards plugged into any connectors in step 740. For example, it is determined whether the extension board is a first-type extension board or a second-type extension board, or whether the transmitting signal is an MPEG TS or an analog video/audio signal. By inquiring of a register indicating configuration when PCI is configured, the CPU 314 can determine this.

Then, the main board CPU 314 transmits a command to the first-type or the second-type extension board, as shown in FIGS. 4 and 6, so that the extension board can execute corresponding functions.

1) As for the first-type extension board shown in FIG. 4, since a program for controlling the extension board is in the program memory 416 in the extension board, execution of the main board CPU 314 program is suspended, control is transferred to the program of the extension board and then the corresponding program is executed. At this time, the program of the extension board should be written in a program code executable by the main board CPU 314. After executing the needed operations, the main board CPU 314 returns to the original program code.

2) As for the second-type extension board shown in FIG. 6, a separate CPU 616 existing on the extension board controls the extension board. Therefore, the main board CPU 314 transmits a command in the form of a message through the PCI bus to the CPU 616 of the extension board. Then, after interpreting the received message, the CPU 616 of the extension board transmits the message in the form of an HTML document through the PCI bus to the main board. At this time, the main board CPU 314 displays the received HTML message, and then again transmits a command input by the user through the PCI bus to the CPU 616 of the extension board.

Next, the main board CPU 314 checks the type of the extension board. By doing so, the main board CPU 314 can determine whether the extension board transmits a broadcasting channel in an MPEG TS or in an analog audio/video signal. Therefore, if a TS is received, the main board CPU 314 operates the MPEG TS decoder 328, the MPEG video decoder 330, and the audio decoder 332 in the main board to display the TS on the screen, and if an analog audio/video signal is received, displays an audio/video signal in the form of an analog signal on the screen.

The present invention is not restricted to the above-described embodiments, and many variations are possible within the spirit and scope of the present invention. That is, the present invention can be applied to various multimedia systems including a modular television, and a set-top box.

According to the present invention as described above, by forming a backplane, into which the main board and extension boards can be plugged, in a multimedia device, the functions of the device can be upgraded by replacing older cards with new extension cards having improved functions, when the user desires to upgrade functions, such as an Internet function. Also, new functions, which were not installed when the device is first shipped, can be additionally installed after buying an extension card when the user desires.

What is claimed is:

1. A multimedia device in a multimedia system, the multimedia device comprising:
a backplane unit having a plurality of connectors provided thereon, each of the connectors having a predetermined signal standard;
a main board unit, which is plugged into a connector of the backplane unit, for processing an MPEG transport stream input from an extension board into a predetermined signal form, and selecting an extension board; and
an extension board, which is attachable to any one of the connectors of the backplane, excluding the connector into which the main board unit is plugged, for transmitting an MPEG transport stream processed by an independent module to the main board unit when selected by the main board unit.

2. A multimedia device in a multimedia system, the multimedia device comprising:
a combination main board unit, wherein a backplane formed of a plurality of connectors, each of the connectors having a predetermined signal standard, and a main board for processing a multimedia input signal into a predetermined signal and selecting an extension board are combined; and
an extension board, which is attachable to any one of the connectors of the backplane, separately from the combination main board, for performing extended functions, according to the main board's selection.

3. The multimedia device of either claim 1 or 2, wherein each connector of the backplane has lines for:
a transmission signal for transmitting a control command of the main board to the extension board;
an MPEG transport stream;
an analog audio/video signal; and
a selection signal for selecting an extension board.

4. The multimedia device of either claim 1 or 2, wherein the main board or the combination main board comprises:
an MPEG TS decoder for decoding a receiving MPEG TS into an MPEG video bit stream and an audio bit stream;
an MPEG video decoder for decoding the MPEG video bit stream generated in the MPEG TS decoder into an analog video signal;
an audio decoder for decoding the audio bit stream generated in the MPEG TS decoder into an analog audio signal; and
a control unit for selecting one of the extension boards, operating the MPEG TS decoder, the audio decoder, and the MPEG video decoder if the MPEG TS data is input from the extension board, and selectively outputting a multimedia signal.

5. The multimedia device of either claim 1 or 2, wherein the extension board includes a module unit for transmitting a TS or an analog audio/video signal to the backplane if the extension board is selected by a control from the main board or the backplane.

6. The multimedia device of either claim 1 or 2, wherein the extension board comprises:
a memory storing a program to execute in the main board or the backplane; and
a module unit for transmitting the TS or analog audio/video signal to the backplane or main board if the extension board is selected by a control from the main board, according to the program stored in the memory.

7. The multimedia device of either claim 1 or 2, wherein the extension board comprises:
a module unit for transmitting a TS or analog audio/video signal to the backplane or the main board according to the control command;
an extended control unit for receiving a command from the main board if the module unit is selected in the main board, controlling the module unit, and then transmitting the result of executing the command to the main board; and
a memory for storing a program to be executed by the extended control unit.

8. The multimedia device of claim 7, wherein if an operation command from the main board is received, the extended control unit transmits menu items in the form of an HTML document to the main board to display the menu items on a screen, and if a menu item displayed is selected in the main board, executes a command corresponding to the selected menu item.

9. The multimedia device of any one of claims 5 through 7, wherein if the main board does not select the module unit, the module unit does not transmit a TS or an analog audio/video signal.

10. A method for extending functions of a multimedia device having a backplane, a main board, and extension boards plugged into the backplane, the method for extending functions comprising the steps of:
(a) determining whether or not the extension boards are plugged into the backplane, by sequentially scanning connectors plugged on the backplane;
(b) analyzing the characteristic of an extension board, if it is determined in the step (a) that the extension board is plugged into the backplane;
(c) performing functions according to the characteristics of the extension board analyzed in the step (b); and
(d) displaying a signal corresponding to the function of the extension board performed in the step (c), on a screen.

11. The method for extending functions of claim 10, wherein the step (c) further comprises the steps of:
the extension board receiving an operation command in the form of a menu, if an operation command is transmitted to the extension board; and
displaying the received menu on the screen by a web browser, and performing a command corresponding to the displayed menu.

12. A multimedia device in a multimedia system, the multimedia device comprising:
a backplane unit formed of a plurality of connectors, each of the connectors having a predetermined signal standard; and
a main board unit, which is plugged into a connector of the backplane unit, for processing an MPEG transport stream, which is input from a board of another connector, into a predetermined signal form, and selecting the board from which the MPEG transport stream was input.

13. The multimedia device of claim 12, wherein each connector of the backplane has lines for:
a transmission signal for transmitting a control command of the main board to the extension board;
an MPEG transport stream;
an analog audio/video signal; and
a selection signal for selecting an extension board.

14. A multimedia device having an extension board, which is detachably plugged into one of a plurality of connectors provided to a backplane and extends functions different from the functions of a main board, wherein the extension board comprises:
a module unit for driving a function extension module and generating a transport stream, and selectively transmitting the transport stream, which is generated in the function extension module, or an analog audio/video signal to the backplane according to a control command;
an extended control unit for receiving a control command from the main board if the module unit is selected in the main board, processing the module unit, and transmitting the result of executing the command to the main board; and
a connector unit for connecting each signal of the module unit and the extended control unit.

15. The multimedia device of claim 14, wherein if an operation command from the main board is received, the extended control unit transmits menu items to the main board to display the menu items on a screen, and if a menu item displayed is selected in the main board, executes a command corresponding to the selected menu item.
